(19) United States
(12) Patent Application Publication
(10) Pub. No.: US 2007/0297020 A1
(43) Pub. Date: Dec. 27, 2007

(54) Image-sensing module using white LEDs as a light source thereof

(76) Inventors: Chi-Ting Shen, Hsin-Tien City (TW); Chia-Cheng Lei, Hsin-Tien City (TW); Hsueh-Ping Chen, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/471,589

(22) Filed: Jun. 21, 2006

(51) Int. Cl. H04N 1/04

(52) U.S. Cl. 358/474; 358/483

(57) ABSTRACT

An image-sensing module using white LEDs as a light source thereof comprises a printed circuit board, a contact image-sensing element, a rod lens, and a white LED element, wherein the contact image-sensing element is mounted on the printed circuit board, the rod lens provided above the contact image-sensing element, and the white LED element is provided on a side of the rod lens. The white LED element emits a light beam to a document to generate a light reflected from the document to the contact image-sensing element, and then the contact image-sensing element can sense the image of the document via the rod lens.

### BACKGROUND OF THE INVENTION

1. Field of the Invention

The present invention relates to an image-sensing module using white light emitting diodes (referred to as “LEDs” hereinafter) as a light source thereof and, in particular, to a contact image sensor (referred to as “CIS” hereinafter) using LEDs as a light source thereof.

2. Description of the Related Art

It is well known that CISs are cheap and easily built. Compared with charge couple devices (referred to as “CCDs” hereinafter), CISs are possible to replace CCDs at a certain level when they have been successfully developed from low resolution to high resolution nowadays. Especially, CISs are highly competitive in the low resolution and low price markets, such as home scanners and fax machines. Therefore, CIS manufactures are actively improving CIS technology.

On the other hand, regarding the light source required by the image sensor, traditional color image sensors adopt the white light generated by cold cathode fluorescent lamps (referred to as “CCFLs” hereinafter) as their light sources to meet the requirements of high-speed operation.

However, the prior contact image-sensing module (referred to as “CIS module” hereinafter) adopting CCFLs as the light source has the following drawbacks:

1. CCFLs need AC power, but the contact image-sensing element itself needs DC power. Therefore, CCFLs need an additional transformer, and the whole system becomes complicated.

2. Only CCFLs need a period of time to warm up, meaning the response time of the CCFLs is not necessary to the contact image-sensing element. The operation of this CIS module that uses the light source of CCFLs is not efficient.

3. The size of CCFLs is not tiny and thus the CIS module occupies a certain amount of space. Furthermore, since CCFLs are utilized as the light source, adjusting the length of the CIS module is inflexible.

Therefore, in view of the above drawbacks, the inventor proposes the present invention to overcome the above problems based on his deliberate research and related principles.

### SUMMARY OF THE INVENTION

One particular aspect of the present invention is to provide an image-sensing module using white light emitting diodes as a light source thereof More specific, the invention provides a CIS module using white light emitting diodes as a light source thereof. The invention has the following merits:

1. The white LEDs and the image-sensing element can share the DC supply. Therefore, no additional transformer is required during the operation of the CIS module.

2. The white LEDs need no warm-up time when they are first turned on, and the operation of the CIS is faster and more convenient.

3. Since the light source is composed of several white LEDs arranged in a row, the size of the CIS module can be reduced. Further, the adjustment of the length of the light source is pretty flexible.

4. The ingredients of the white LEDs are harmless chemicals. The white LEDs can serve as an environmental friendly, and is a clean light source.

5. The life cycle of the white LEDs is long, and the quality of the image sensing operation is stable.

6. The brightness of the white LEDs is higher, and thus the white LEDs present a better performance when the CIS module senses the gray scale documents.

According to the present invention, the CIS module using white light emitting diodes as a light source thereof comprises a printed circuit board, a contact image-sensing element, a rod lens and a white light emitting diode element, wherein the contact image-sensing element is mounted on the printed circuit board, the rod lens is provided above the contact image-sensing element, and the white light emitting diode element is provided on one side of the rod lens. The white LED element emits a light beam to a document to generate a light reflected from the document to the contact image-sensing element, and thus the contact image-sensing element can sense the image of the document via the rod lens.

For further understanding of the invention, the reference is made to the following detailed description to illustrate the embodiments and examples of the invention. The description is only for illustrating the invention and is not intended to be considered limiting the scope of the claim.

### BRIEF DESCRIPTION OF THE DRAWINGS

The characteristics and the technical contents of the present invention will be further understood in view of the detailed description and accompanying drawings. However, it should be noted that the drawings are illustrative, but not used to limit the scope of the present invention. Wherein:

FIG. 1 is an exploded perspective view illustrating the CIS module using the white LEDs as a light source thereof according to the present invention; and

FIG. 2 is a side cross-sectional view illustrating the CIS module using the white LEDs as a light source thereof shown in FIG. 1.

FIG. 3 is a top view illustrating a contact image-sensing element including a plurality of pixels.

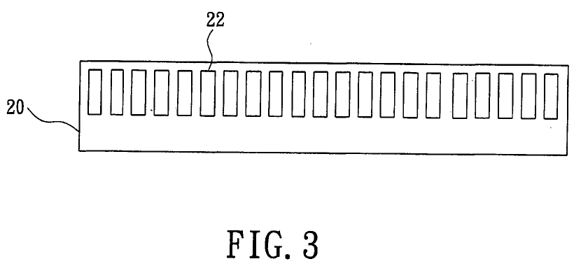

FIG. 4 is a top view illustrating one pixel having four photodiodes, one photodiode is non-coated, and the other three photodiodes are coated with the coating layers that have the colors of red, green, and blue respectively.

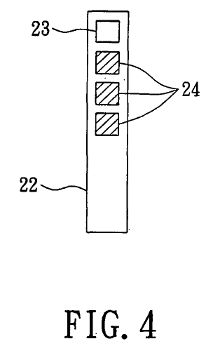

### DETAILED DESCRIPTION OF THE PREFERRED EMBODIMENTS

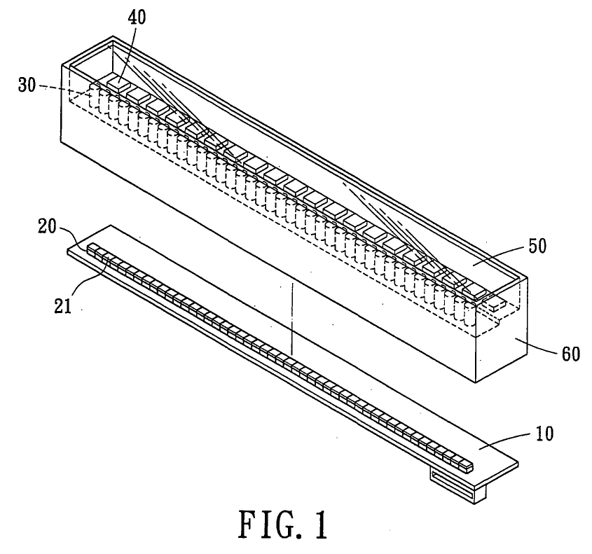

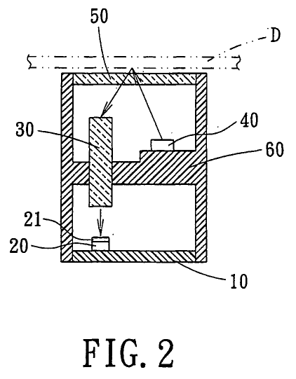

Referring to FIG. 1 and FIG. 2, a contact image-sensing (CIS) module using white LEDs as a light source thereof comprises a printed circuit board 10, a contact image-sensing element 20, a rod lens 30, and a white LED element 40.

The contact image-sensing element 20 is mounted on the printed circuit board 10. The contact image-sensing element 20 is a single contact image-sensing element or is comprised of a plurality of contact image-sensing elements arranged in a line. Furthermore, the rod lens 30 is comprised of a plurality of column-shaped lenses arranged in a line. The white LED element 40 is provided on one side of the rod lens 30, and the white LED element 40 is comprised of a plurality of the white LEDs arranged in a line. Additionally, the white LED element 40 can be made of a blue LED and phosphor, or a red LED, a green LED, and a blue LED turned on at the same time.

The contact image-sensing element 20 is composed of many pixels 22. Each pixel 22 has four photodiodes. One photodiode of the pixel that is not coated with the coating layer is non-coated photodiode 23. The other three photodiodes of the pixel that are coated with the coating layers 21 that contain three colors of red, green and blue respectively are called coated photodiodes 24. The contact image-sensing element 20 has two operating mode: mono mode, and color mode. When the contact image-sensing element operates in the mono mode, the non-coated photodiode 23 of the pixel is activated, and the other three coated photodiodes 24 of the pixel are not activated. There are only one signal output terminal at this mono mode. On the other hand, when the contact image-sensing element operates in the color mode, the non-coated photodiode 23 of the pixel is not activated, and the other three coated photodiodes 24 of the pixel are activated. There are three signal output terminals, a red signal output terminal, a green signal output terminal, and a blue signal output terminal at this color mode. All the three signal output terminals output data synchronously to achieve high speed transmission.

The white LED element 40 emits a light beam (such a light beam can be directly obtained from a white LED or indirectly obtained by mixing up the lights emitted from the red, green and blue LEDs or mixing up the lights emitted from the blue LED and phosphor) to a document D to generate a light reflected from the document D to the contact image-sensing element, and thus the contact image-sensing element 20 can sense the image of the document via the rod lens 30.

According to the present invention, the image-sensing module further comprises a glass 50 provided above the rod lens 30 and the white LED element 40. Furthermore, the printed circuit board 10, contact image-sensing element 20, rod lens 30, white LED element 40 and glass 50 are accommodated inside the shell 60.

To sum up, according to the present invention, the image-sensing module has the following advantages: fast scanning, color scanning, tiny volume, only DC supply required, no warming-up for the light source thanks to the white LEDs, and thus greatly improve the scanning efficiency of the image-sensing module.

Although the present invention has been described with reference to the foregoing preferred embodiment, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A contact image-sensing module using white LEDs as a light source thereof, the contact image-sensing module comprising:
a printed circuit board;
a contact image-sensing element mounted on the printed circuit board;
a rod lens provided above the contact image-sensing element; and
a white light emitting diode element provided on one side of the rod lens, wherein the white light emitting diode element emits a light beam to a document to generate a light reflected from the document to the contact image-sensing element, and thus the contact image-sensing element can sense the image of the document via the rod lens.

2. The contact image-sensing module using white light emitting diodes as a light source thereof as claimed in claim 1, wherein the contact image-sensing element is a single contact image-sensing element or a plurality of contact image-sensing elements arranged in a line.

3. The contact image-sensing module using white light emitting diodes as a light source thereof as claimed in claim 2, wherein the contact image-sensing element comprises a plurality of pixels, and each pixel has four photodiodes for sensing light.

4. The contact image-sensing module using white light emitting diodes as a light source thereof as claimed in claim 3, wherein three of the photodiodes are coated with the coating layers thereon respectively.

5. The contact image-sensing module using white light emitting diodes as a light source thereof as claimed in claim 4, wherein the coating layers includes three colors that are red, green and blue.

6. The contact image-sensing module using white light emitting diodes as a light source thereof as claimed in claim 5 wherein the contact image-sensing element has two operating mode, that is mono mode and color mode; when the contact image-sensing element operates in mono mode, the non-coated photodiode of each pixel of the contact image-sensing element has activated, and there are only one signal output terminal at this mono mode; when the contact image-sensing element operates in color mode, three of the photodiodes coated with red, green, and blue color coating layers respectively of each pixel of the contact image-sensing element has activated, and there are three signal output terminals, a red light signal output terminal, a green light signal output terminal and a blue light signal output terminal, respectively, and the three signal output terminals output signals synchronously at this color mode.

7. The contact image-sensing module using white light emitting diodes as a light source thereof as claimed in claim 1, wherein the rod lens comprises a plurality of column-shaped lenses arranged in a line.

8. The contact image-sensing module using white light emitting diodes as a light source thereof as claimed in claim 1, wherein white light emitting diode element comprises a plurality of white light emitting diodes arranged in a line.

9. The contact image-sensing module using white light emitting diodes as a light source thereof as claimed in claim 1, further comprising a glass provided above the rod lens and the white light emitting diode element.

10. The contact image-sensing module using white light emitting diodes as a light source thereof as claimed in claim 1, wherein the white light emitting diode element comprises a blue light emitting diode and phosphor.

11. The contact image-sensing module using white light emitting diodes as a light source thereof as claimed in claim 1, wherein the white light emitting diode element comprises a red light emitting diode, a green light emitting diode and a blue light emitting diode, and all the light emitting diodes are turned on synchronously to generate the white light.
